(19) United States
(12) Patent Application Publication
(10) Pub. No.: US 2026/0127916 A1
(43) Pub. Date: May 7, 2026

(54) NOTIFICATION SYSTEM FOR ELECTRIC VEHICLES

(71) Applicant: DENSO CORPORATION, Kariya-city (JP)

(72) Inventors: Kazuma KAWAI, Kariya-city (JP); Mitsuharu HIGASHITANI, Kariya-city (JP); Noriaki IKEMOTO, Kariya-city (JP)

(73) Assignee: DENSO CORPORATION, Kariya-city (JP)

(21) Appl. No.: 19/376,257

(22) Filed: Oct. 31, 2025

(30) Foreign Application Priority Data
Nov. 6, 2024 (JP) 2024-194467

(51) Int. Cl. G07C 5/00; B60L 58/12; G01C 21/34; G01C 21/36

(52) U.S. Cl. CPC G07C 5/004; B60L 58/12; G01C 21/3469; G01C 21/3679; G07C 5/008; B60L 2240/62

(57) ABSTRACT

In a notification system for an electric vehicle that travels based on power acquired from a secondary battery, a charging facility determination unit determines, during traveling of the electric vehicle, whether a charging facility comes within a predetermined determination range defined with reference to a current position of the electric vehicle. A notification control unit estimates an insufficient battery-charge possibility of the electric vehicle, the insufficient battery-charge possibility denoting a possibility that an insufficient charge of the secondary battery of the electric vehicle occurs. The notification control unit performs a notification based on the insufficient battery-charge possibility of the electric vehicle in response to determination that the charging facility comes within the predetermined determination range.

### CROSS-REFERENCE TO RELATED APPLICATION

This present application is based on and claims the benefit of priority from Japanese Patent Application No. 2024-194467 filed on Nov. 6, 2024, the disclosure of which is incorporated herein by reference.

### TECHNICAL FIELD

The present disclosure relates to notification systems for electric vehicles.

### BACKGROUND

Japanese Patent Application Publication 2016-118403 discloses a battery-depletion warning system for an electric vehicle.

The battery-depletion warning system obtains the amount of electric energy required for the electric vehicle to reach a destination from its current location. Then, the system compares a ratio of the required energy to a remaining battery capacity with a plurality of thresholds to evaluate the likelihood of battery depletion at multiple stepwise levels. The system performs an issuance of a warning in a mode corresponding to the evaluated level. The term “battery depletion or insufficient battery charge” of an electric vehicle used herein refers to a state in which electric power available from a secondary battery mounted to the electric vehicle is insufficient.

### SUMMARY

For long-distance travel of electric vehicles, use of charging facilities is indispensable to avoid insufficient battery charge. However, the system disclosed in the patent publication does not consider the locations of charging facilities. This may result in electric vehicles traveling while overlooking a charging facility and therefore passing by the charging facility. After detailed consideration by the inventors, the inventors have identified the above issue.

In view of the above issue, the present disclosure seems to provide a notification system capable of appropriately notifying, when an electric vehicle approaches a charging facility, information related to insufficient battery charge to accordingly prevent the electric vehicle from unintentionally passing a charging facility.

An exemplary aspect of the present disclosure provides a notification system for an electric vehicle that travels based on power acquired from a secondary battery. The system includes a charging facility determination unit configured to determine, during traveling of the electric vehicle, whether a charging facility comes within a predetermined determination range defined with reference to a current position of the electric vehicle. The system includes a notification control unit configured to estimate an insufficient battery-charge possibility of the electric vehicle, the insufficient battery-charge possibility denoting a possibility that an insufficient charge of the secondary battery of the electric vehicle occurs, and perform a notification based on the insufficient battery-charge possibility of the electric vehicle in response to determination that the charging facility comes within the predetermined determination range.

This configuration of the notification system according to the exemplary aspect enables, when the electric vehicle is approaching the charging facility, the occupant to recognize, through the notification performed based on the insufficient battery-charge possibility of the electric vehicle, not only the fact that the electric vehicle is approaching the charging facility but also the insufficient battery-charge possibility of the electric vehicle. Thus, the notification system according to the exemplary aspect makes it possible to, when the electric vehicle approaches the charging facility, appropriately provide a notification that aims to prevent insufficient battery charge, thus preventing the electric vehicle from passing, due to the driver's inattention, the charging facility.

Where reference characters are used in parentheses for various elements throughout the present disclosure, such characters are provided merely as an example of the correspondence between the elements and the specific structures in the embodiments described later. The present disclosure is therefore not limited by the use of such reference characters.

### BRIEF DESCRIPTION OF THE DRAWINGS

Other aspects of the present disclosure will become apparent from the following description of embodiments with reference to the accompanying drawings in which:

FIG. 1 is a side view schematically illustrating a vehicle to which a notification system according to the first embodiment of the present disclosure is to be applied;

FIG. 2 is a block diagram schematically illustrating typical components installed in the vehicle illustrated in FIG. 1 and typical components of a cloud that is communicably connected to the vehicle;

FIG. 3 is a flowchart schematically illustrating a control routine for preparing a travel plan of the vehicle, which includes a scheduled travel route of the vehicle according to the first embodiment;

FIG. 4 is a schematic view two-dimensionally illustrating the scheduled travel route, roads, charging facilities at which the vehicle can be charged, and a current position of the vehicle;

FIG. 5 is a flowchart schematically illustrating a notification control routine to be executed by the notification system;

FIG. 6 is a functional block diagram schematically illustrating functional components included in the notification system according to the first embodiment;

FIG. 7 is a flowchart schematically illustrating a reselection subroutine called to be carried out in step S209 of the notification control routine; and

FIG. 8 is a block diagram, which corresponds to FIG. 2, schematically illustrating typical components installed in the vehicle illustrated in FIG. 1 and typical components of a cloud that is communicably connected to the vehicle according to the second embodiment of the present disclosure.

### DETAILED DESCRIPTION OF EMBODIMENTS

The following describes exemplary embodiments of the present disclosure with reference to accompanying drawings. In the following exemplary embodiments, substantially identical or equivalent components are represented by the same reference characters and redundant explanations are omitted.

### First Embodiment

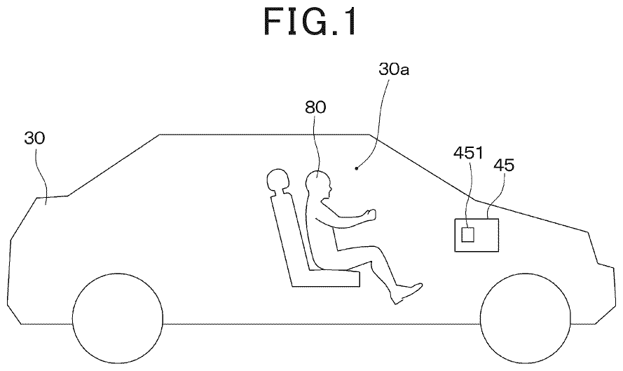

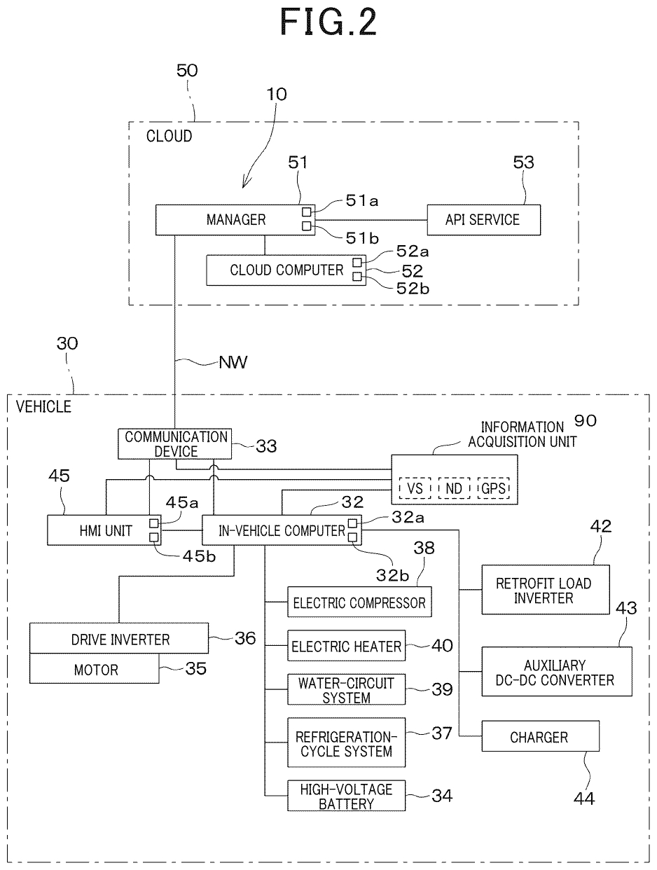

Referring to FIGS. 1 and 2, a notification system 10 according to the first embodiment is a vehicular notification system applicable to, for example, a vehicle, such as an electric vehicle, 30. The electric vehicle as the vehicle 30 according to the first embodiment will also be referred to as a Battery Electric vehicle (BEV), and the vehicle (BEV) 30 includes a high-voltage battery, i.e., a secondary battery, 34, and can travel based on power obtained from the high-voltage battery 34.

Specifically, the notification system 10 is configured to perform a predetermined notification to the cabin 30a of the vehicle 30 when the vehicle 30 approaches a designated charging facility CG at which the vehicle 30 is scheduled to stop for charging of the high-voltage battery 34. That is, the notification system 10 is configured to perform a predetermined notification to an occupant 80, such as a driver of the vehicle 30, when the vehicle 30 approaches such a scheduled charging facility CG.

The notification system 10 includes, as a hardware configuration, an in-vehicle computer 32, a communication device 33, a manager 51, and a cloud computer 52. The in-vehicle computer 32 and the communication device 33, which are provided in the vehicle 30, are connected so as to be capable of communicating information with each other. The manager 51 and the cloud computer 52, which are provided in a cloud, i.e., a cloud server, 50, are connected so as to be capable of communicating information with each other; the cloud 50 is installed on the outside of the vehicle 30.

The cloud, i.e., cloud server, 50 refers to, for example, an external information processing environment that is communicably connected to the vehicle 30 via the wireless network NW. The cloud 50 may be implemented as a physical server, a group of servers, a virtualized environment, or any combination thereof, provided that the functions described herein are realized.

The communication device 33 of the vehicle 30 is connected so as to be capable of wireless communication with the cloud 50, and is configured to perform transmission and/or reception of information between the cloud 50 and each device included in the vehicle 30.

Specifically, the communication device 33 of the vehicle 30 and the manager 51 of the cloud 50 are connected so as to be capable of communicating information with one another via a wireless network NW. The wireless network NW includes, for example, a wireless communication line of 4G or 5G and the Internet.

The in-vehicle computer 32, the manager 51, and the cloud computer 52 each have a configuration as a microcomputer provided with a CPU 32a, 51a, 52a and a storage 32b, 51b, 52b including, for example, a RAM, a ROM, and a non-volatile rewritable memory.

Each of the in-vehicle computer 32, the manager 51, and the cloud computer 52 reads and executes computer programs, i.e., computer-program instructions, stored in the corresponding ROM or the non-volatile rewritable memory. Each of the ROM and the non-volatile rewritable memory serves as a non-transitory tangible storage medium. Executing the computer programs enables methods corresponding to the computer programs to be carried out.

That is, each of the in-vehicle computer 32, the manager 51, and the cloud computer 52 executes various control processes in accordance with the corresponding computer programs.

Each of the in-vehicle computer 32, the manager 51, and the cloud computer 52 is capable of executing control processing independently. Additionally, because the in-vehicle computer 32, the manager 51, and the cloud computer 52 are capable of information communication with one another, the in-vehicle computer 32, the manager 51, and the cloud computer 52 are capable of cooperating with each other to execute one control process as if they were a single computer.

As illustrated in FIG. 2, the vehicle 30 according to the first embodiment includes, in addition to the in-vehicle computer 32 and the communication device 33 described above, the high-voltage battery 34, a motor 35, a drive inverter 36, a refrigeration-cycle system 37, an electric compressor 38, a water-circuit system 39, and an electric heater 40. Additionally, the vehicle 30 includes a retrofit load inverter 42, an auxiliary DC (direct current)-DC converter 43, a charger 44, and an HMI (Human Machine Interface) 45.

The high-voltage battery 34 is a rechargeable secondary battery, and is constituted by, for example, a lithium ion battery or a nickel-hydrogen battery or a nickel-metal-hydride battery. The high-voltage battery 34 serves as a vehicle power supply that supplies current to each of the electric devices, which include the drive inverter 36, installed in the vehicle 30.

The motor 35 is a traction motor that rotationally drives drive wheels of the vehicle 30. Specifically, the motor 35 is configured to receive electric power supplied from the drive inverter 36 to accordingly rotate the driving wheels of the vehicle 30, thus propelling the vehicle 30. The drive inverter 36 is configured to convert a direct current from the high-voltage battery 34 into an alternating current, and supply the converted alternating current to the motor 35, thus rotating the motor 35.

The refrigeration cycle system 37 includes, for example, a plurality of heat exchangers, an expansion valve, a flow path switching valve. The refrigeration cycle system 37 and the electric compressor 38 constitute a refrigeration cycle circuit in which a refrigerant is circulated. In the refrigeration cycle circuit, circulation of the refrigerant enables a vapor compression refrigeration cycle to be executed. Execution of the refrigeration cycle enables temperature adjustment of the high-voltage battery 34, the motor 35, and the drive inverter 36, and air conditioning in the cabin 30a to be carried out.

The electric compressor 38 is configured to operate based on power supplied from the high-voltage battery 34 to draw in the refrigerant in the refrigeration cycle circuit, compress the refrigerant, and then discharge the compressed refrigerant. That is, the refrigerant is circulated in the refrigeration cycle circuit based on operation of the electric compressor 38, and the circulation of the refrigerant enables heat to be transferred from one of the plurality of heat exchangers to another based on the circulation of the refrigerant.

The water circuit system 39 includes a pump and one or more heat exchangers that constitute a water circuit in which a liquid medium such as cooling water is circulated. For example, at least one of the heat exchangers provided across both the water circuit and the refrigeration cycle circuit causes liquid medium in the water circuit to exchange heat with the refrigerant in the refrigeration cycle circuit. That is, the water circuit cooperates with the refrigeration cycle circuit to perform both (i) temperature adjustment of each of the thermal-management target devices connected to the water circuit, such as the high-voltage battery 34, the motor 35, and the drive inverter 36 and (ii) air conditioning in the vehicle cabin 30a.

The electric heater 40 is disposed, for example, in a cabin air-conditioning unit, and is configured to generate heat based on power supplied from the high-voltage battery 34. Specifically, the electric heater 40 is configured to heat air, which is to be blown out from the cabin air-conditioning unit into the cabin 30a, within the cabin air-conditioning unit.

The retrofit load inverter 42 is an inverter for supplying power to one or more electrical loads retrofittable to the vehicle 30, that is, retrofit electrical loads. The retrofit load inverter 42 is configured to convert a voltage, i.e., a high voltage, across the high-voltage battery 34 into a voltage suitable for the one or more retrofit electrical loads, and supply power based on the converted voltage to the one or more retrofit electrical loads. For example, the one or more retrofit electrical loads may include household appliances, such as a portable refrigerator-freezer connected to an AC 100 V outlet provided in the vehicle 30.

The auxiliary DC-DC converter 43 is configured to convert high-voltage power, which is the voltage, i.e., the high voltage across the high-voltage battery 34, into low-voltage power with a predetermined low voltage, such as DC 12 V or DC 48 V. The auxiliary DC-DC converter 43 is configured to supply the converted low-voltage power to each of auxiliaries, which are a plurality of general electric loads of the vehicle 30.

The charger 44 includes a charging socket into which a charging plug for supplying power from outside the vehicle 30 to the vehicle 30 is insertable, and an electric circuit for controlling the supply of the electric power. The charger 44 is configured to adjust the voltage of the power supplied from outside the vehicle 30 and thereafter supply the adjusted power to the high-voltage battery 34. This enables the high-voltage battery 34 to be charged.

The high-voltage battery 34, the motor 35, the drive inverter 36, the refrigeration cycle system 37, the electric compressor 38, the water circuit system 39, the electric heater 40, the retrofit load inverter 42, the auxiliary DC-DC converter 43, and the charger 44 described above are each electrically connected to the in-vehicle computer 32.

The in-vehicle computer 32 is configured to output control signals indicating final command values to the controlled devices while preventing insufficient battery charge of the vehicle 30.

The HMI unit 45 is comprised of an interface unit 45a and a controller 45b having an input function of inputting, through the interface unit 45a, various data items from the occupant 80 as a user, and an output function of providing, through the interface unit 45a, various information the occupant 80. Examples of the HMI unit 45 include, as the interface unit 45a, a touch-panel display having a display function as the output function and the input function, and is provided on an instrument panel in the cabin 30a.

Examples of the input information, which is input from the occupant 80 through the interface unit 45a of the HMI unit 45, include a destination to be used for travel planning by the cloud computer 52, which will be described later, and requests of the occupant 80 related to the travel planning. Examples of the requests of the occupant 80 include a desired value for the remaining energy of the high-voltage battery 34 when the vehicle 30 arrives at the destination, or a desired level of the remaining energy of the high-voltage battery 34, such as low, medium, or high.

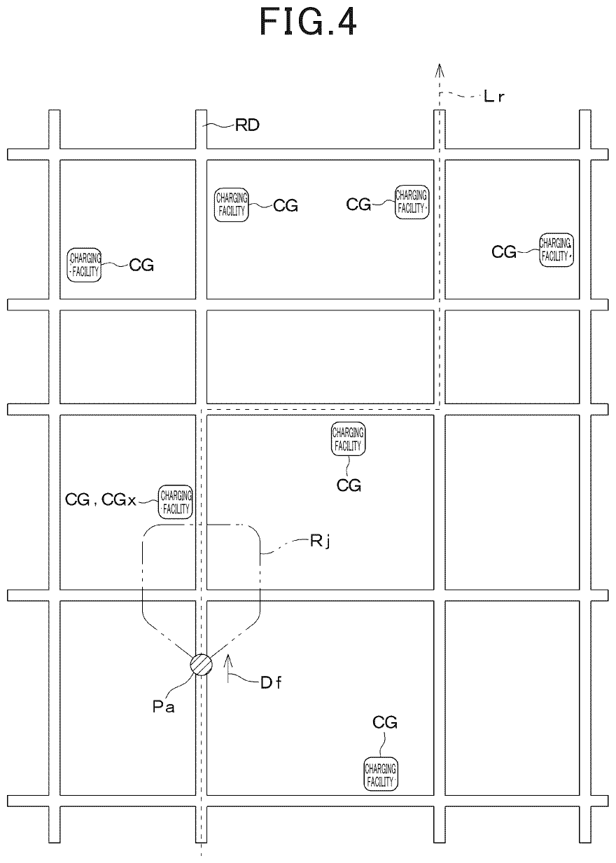

Examples of the output information, which is output through the interface unit 45a of the HMI unit 45 to the occupant 80, include information indicating a recommended travel route in the travel planning. Additionally, examples of the output information, which is output through the interface unit 45a of the HMI unit 45 to the occupant 80, include respective positions of charging facilities CG (see FIG. 4) available in the travel planning and a speed sequence of the vehicle 30 to be used in the travel planning.

Information that is to be provided to the in-vehicle computer 32 without being provided to the occupant 80 is transmitted from the cloud 50 to the vehicle 30, so that the information is received by the in-vehicle computer 32. Examples of the information to be provided to the in-vehicle computer 32 include a target temperature for controlling the temperature of the high-voltage battery 34 in preparation for charging the high-voltage battery 34. The remaining energy of the high-voltage battery 34 will also be referred to simply as a charging level or a charging remaining level of the high-voltage battery 34. The charging facilities CG will also be referred to as charging stations. The high-voltage battery 34 can be charged from the charger 44 illustrated in FIG. 2 at each of the charging facilities CG.

The vehicle 30 further includes an information acquisition unit 90. The information acquisition unit 90 is connected to the in-vehicle computer 32 and the communication device 33, and is configured to acquire vehicle state information, such as a vehicle speed, a current vehicle position, or a battery state, from at least one of various sensors VS, a navigation device ND, GPS (Global Positioning System), or an API service 53 provided in the cloud 50. API is an abbreviation of “Application Programming Interface.”

The manager 51 of the cloud 50 functions to aggregate information transmitted and received among (i) the communication device 33 of the vehicle 30, (ii) the API service 53 provided in the cloud 50, and (iii) the cloud computer 52.

The cloud computer 52 is configured to receive various information, which include the information input from the HMI unit 45 via the manager 51, and, for example, calculate a travel plan related to energy of the vehicle 30 traveling to the occupant's requested destination in accordance with a purpose of the occupant 80. If information regarding the vehicle 30 is required for the calculation of the travel plan, the information is transmitted as appropriate from the vehicle 30 to the cloud 50. For example, the information can be inputted from the HMI unit 45 to the could 52 set forth above.

Examples of the information regarding the vehicle 30 include various information items respectively indicating (i) a present level of the remaining energy of the high-voltage battery 34, (ii) a value of the temperature of the high-voltage battery 34, and (iii) a current position Pa of the vehicle 30.

The travel plan calculated and completed by the cloud computer 52 is transmitted via the manager 51 and the wireless network NW to the communication device 33 of the vehicle 30. When functions related to calculation of the travel plan are distributed among a plurality of computers, the manager 51 also has a function of integrally controlling the plurality of computers.

The API service 53 is, for example, implemented on a server in the cloud 50. When defining the API service 30 in the cloud 50, one of its functions is to act as a mechanism that allows hardware/software components within the cloud 50 to communicate with (i) other internal cloud components and (ii) external hardware/software components, through a predefined set of definitions and protocols.

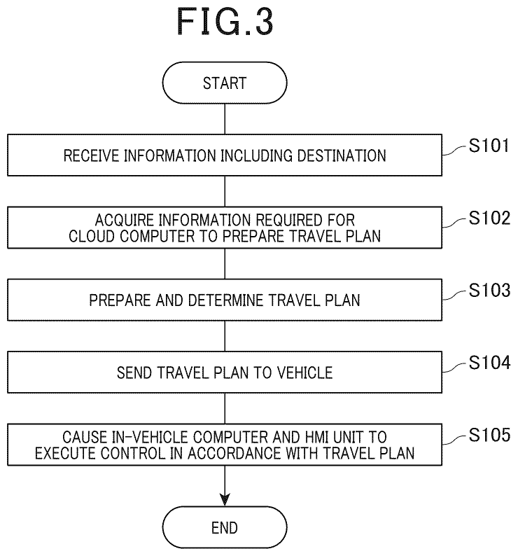

Specifically, the cloud computer 52 and the manager 51 of the cloud 52 are cooperatively configured to prepare a travel plan for the vehicle 30 in accordance with the flowchart illustrated in FIG. 3. The cloud computer 52 is configured to start the control routine illustrated in the flowchart of FIG. 3 in response to occupant's manual operations through the HMI unit 45. The travel plan is a plan of travel of the vehicle 30 that is determined prior to actual travel of the vehicle 30. The travel plan is comprised of a plurality of information items including, for example, (i) a scheduled travel route Lr (see FIG. 4) recommended in the travel plan, (ii) at least one charging facility CG selected to be stopped during the scheduled travel route Lr, (iii) a transition in a target speed of the vehicle 30 during travelling of the vehicle 30, and (iv) a transition in the target temperature of each in-vehicle device.

When starting the control routine, the cloud computer 52 receives information, which is input thereto by occupant's information input operations through the HMI unit 45 in step S101. The information input operations by the occupant 80 herein means that the occupant 80 inputs, through the interface unit 45a of the HMI unit 45, information to the controller 45b of the HMI unit 45; the cloud computer 52 is configured to refer to the input information for preparing a travel plan. For example, as the information input operations, the occupant 80 inputs, through the interface unit 45a of the HMI unit 45, a destination of the travel plan.

In addition, the occupant 80 may also input, through the interface unit 45a of the HMI unit 45, (i) a desired value of the remaining energy of the high-voltage battery 34 or a desired level of the remaining energy when the vehicle 30 arrives at the destination, (ii) permission or prohibition of use of toll roads in the travel plan, and (iii) preference information indicating preferences of the occupant 80.

Examples of the preference information include information on the adjustment of the strength of air conditioning in the cabin 30a and/or information indicative of whether priority is given to travel time or to energy efficiency in the travel planning.

Various methods of occupant's input operations through the interface unit 45a of the HMI unit 45 for example include, when a touch panel display is provided as the interface unit 45a, occupant's operation of one or more visual switches and/or one or more extendable visual bars displayed on the touchscreen of the touch panel display. The input information entered into the controller 45b of the HMI unit 45 is transmitted from the controller 45b to the cloud computer 52 via the communication device 33 and the wireless network NW.

After the operation in step S101 of FIG. 3, the control routine proceeds to step S102.

In step S102, the cloud computer 52 acquires travel-plan basic information, which is information required to determine (i) a scheduled travel route Lr, which is illustrated in, for example, FIG. 4, in a travel plan of the vehicle 30, (ii) a sequence of target vehicle speeds during travel of the vehicle 30, and (iii) a sequence of target temperatures of each in-vehicle device. Examples of the travel plan basic information include the information including the destination entered in step S101, the external information, which includes (i) information indicative of the ambient temperature around the vehicle 10 and (ii) information indicative of traffic congestion around the vehicle 30. Examples of the travel plan basic information include vehicle information indicating the conditions of the vehicle 30, such as at least one of vehicle-speed information indicating the speed of the vehicle 30 and battery information indicating the present state (for example, the SOC and temperature) of the high-voltage battery 34.

In step S102, the cloud computer 52 obtains, from, for example, the API service 53, the external information.

FIG. 4 illustrates, in addition to a scheduled travel route Lr, roads RD around the vehicle 30, charging facilities CG at which the vehicle 30 can be charged, a current position Pa of the vehicle 30 (i.e., a vehicle current position Pa), and a traveling direction Df of the vehicle 30 (i.e., a vehicle traveling direction Df).

After the operation in step S102 of FIG. 3, the control routine proceeds to step S103.

In step S103, the cloud computer 52 prepares and determines the travel plan, which includes the scheduled travel route Lr, of the vehicle 30 based on the travel plan basic information acquired in step S102. For example, the cloud computer 52 determines the travel plan using, for example, a known optimization algorithm. For example, when a plurality of travel-route candidates are provided by the existing API service 53, the cloud computer 52 selects one travel-route candidate from the plurality of travel-plan candidates, and determines the selected travel-route candidate as the scheduled travel route Lr of the travel plan.

The scheduled travel route Lr along which the vehicle 30 is going to travel from the current position Pa to the destination is comprised of a plurality of predetermined sections.

In step S103, the cloud computer 52 determines the position of at least one charging facility CG at which the vehicle 30 can stop along the scheduled travel route Lr for battery charging.

Additionally, in step S103, the cloud computer 52 determines various parameters, which include, for example, (i) the amount of charging energy at the at least one charging facility CG, (ii) a sequence of values of the target speed of the vehicle 30 at the respective sections of the scheduled travel route Lr, and (iii) a sequence of values of the target temperature of each in-vehicle device at the respective sections of the scheduled travel route Lr. An evaluation function is defined for the various parameters such that a higher evaluation corresponds to a larger value, and the various parameters are determined so that the evaluation function value is maximized. Examples of the evaluation function include a function defined to increase with improvement of travel time, energy efficiency, remaining energy of the high-voltage battery 34, and/or risk of insufficient battery charge.

After the operation in step S103 of FIG. 3, the control routine proceeds to step S104.

In step S104, the cloud computer 52 sends the travel plan determined in step S103 to the manager 51, and the manager 51 transmits the travel plan to the vehicle 30 via the wireless network NW.

The travel plan includes, in addition to the scheduled travel route Lr, for example, (i) the position of the at least one charging facility CG at which the vehicle 30 can stop along the scheduled travel route Lr for battery charging, (ii) the amount of charging energy at the at least one charging facility CG, (iii) the sequence of target speeds of the vehicle 30 at the respective sections of the scheduled travel route Lr, and (iv) the sequence of target temperatures of each in-vehicle device. Additionally, the travel plan includes, in addition to the above parameters, groups of target parameters relating to energy in respective sections and respective points of the scheduled travel route Lr.

After the operation in step S104 of FIG. 3, the control routine proceeds to step S105.

In step S105, the manager 51 causes the in-vehicle computer 32 and the HMI unit 45 to execute control in accordance with the travel plan. For example, this enables the HMI unit 45 to present information based on the travel plan, such as the scheduled travel route Lr and a target vehicle speed in the present section corresponding to the current position Pa of the vehicle 30, to the occupant 80 as the driver. In addition, this enables the in-vehicle computer 32 to control, in response to instructions from the manager 51, selected in-vehicle devices in accordance with the travel plan.

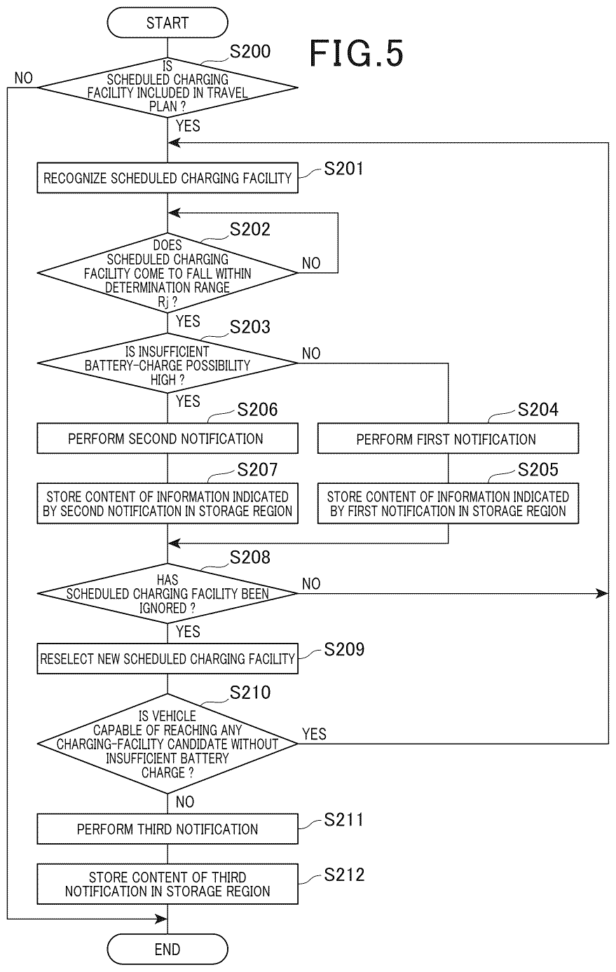

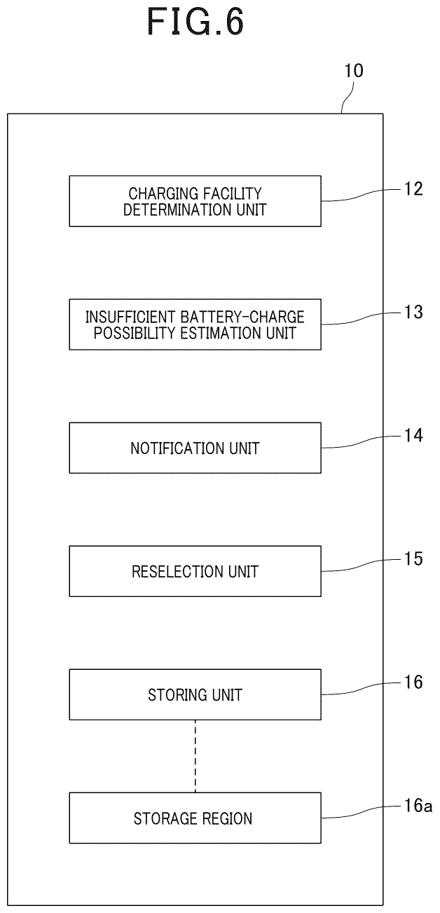

When the vehicle 30 starts traveling in accordance with the travel plan, a notification control routine illustrated in the flowchart illustrated in FIG. 5 is started in the notification system 10 of the first embodiment. For execution of the notification control routine illustrated in FIG. 5, for example, the notification system 10 functionally includes, as illustrated in FIG. 6, a charging facility determination unit 12, an insufficient battery-charge possibility estimation unit 13, a notification unit 14, a reselection unit 15, and a storing unit 16. The charging facility determination unit 12, the insufficient battery-charge estimation unit 13, the notification unit 14, the reselection unit 15, and the storing unit 16 according to the first embodiment are included in the manager 51, which serves as, for example, a control circuitry, of the cloud 50 in the notification system 10.

The notification control routine illustrated in FIG. 5 is configured to perform notification on the premise that the occupant 80 drives the vehicle 30 in accordance with the travel plan determined in the control routine illustrated in FIG. 3. Accordingly, the notification control routine is configured to be terminated if the occupant 80, i.e., the driver 80, continues to drive the vehicle 30 such that the traveling of the vehicle 30 deviates from the travel plan determined in the control routine illustrated in FIG. 3 beyond a predetermined allowable limit. The traveling of the vehicle 30, which deviates from the travel plan beyond the predetermined allowable limit includes, for example, a case where the vehicle 30 continuously travels for at least a predetermined time on a travel route different from the scheduled travel route Lr.

When starting the notification control routine illustrated in FIG. 5, the notification system 10 determines whether the travel plan determined in the control routine illustrated in FIG. 3 includes any scheduled charging facility CGx at which the vehicle 30 is scheduled to stop in step S200. If the travel plan does not include any scheduled charging facility CGx (NO in step S200), the notification control routine is terminated.

Otherwise, if at least one scheduled charging facility CG is included in the travel plan (YES in step S200), then the notification system 10 recognizes information on a scheduled charging facility CG to be used next, which will be referred to as CGx in step S201. That is, the scheduled charging facility CGx is selected in advance, during preparation of the travel plan or in the operation in step S209 described later, from among charging facilities CG located along the scheduled travel route Lr as shown in FIG. 4. As described above, the travel route Lr is predetermined in the travel plan. The scheduled charging facility CGx may be updated in the travel plan, for example, to reflect completion of charging at the scheduled charging facility CGx.

The information on the scheduled charging facility CGx includes, for example, position information on the scheduled charging facility CGx, information on charging power of the scheduled charging facility CGx, and adjacent-road-type information indicating whether the road connected to the scheduled charging facility CGx is a toll road or a general road. The information on the scheduled charging facility CGx may include a usage status and a reservation status of the scheduled charging facility CGx. The road connected to the scheduled charging facility CGx means a road to which the scheduled charging facility CGx is adjacent. Following the operation in step S201, the notification control routine proceeds to step S202.

It is to be noted that various kinds of information required in each step of the control process of FIG. 5 are obtained as appropriate from, for example, the information acquisition unit 90 and the communication unit 33, i.e., the various sensors VS, the navigation device ND of the vehicle 30, the API service 53 of the cloud 50, the GPS, or the other available sources including input information previously described.

Next, the charging-facility determination unit 12 of the notification system 10 determines whether the scheduled charging facility CGx comes within, i.e., enters within, a predetermined determination range Rj while the vehicle 30 is traveling in step S202.

For example, as illustrated in FIG. 4, the determination range Rj is defined to have a predetermined shape, such as a circular or a polygonal shape and a predetermined area with reference to the current position Pa of the vehicle 30. The positional relationship between the determination range Rj and the scheduled charging facility CGx enables determination of whether the vehicle 30 has approached the scheduled charging facility CGx. For example, the determination range Rj is formed to extend forward in the traveling direction Df from the current position Pa of the vehicle 30.

The determination range Rj may be a fixed range or a variable range determined in accordance with information serving as various parameters. For example, the charging-facility determination unit 12 is configured to determine the determination range Rj based on (i) the information on the current position Pa of the vehicle 30, (ii) information on the position of the scheduled charging facility CGx, (iii) the vehicle information set forth above, (iv) surrounding information around the vehicle 30, (v) surrounding information around the scheduled charging facility CGx, and (vi) time information. Then, the charging-facility determination unit 12 is configured to determine whether the scheduled charging facility CGx comes within the determination range Rj while the vehicle 30 is traveling.

The information on the vehicle current position Pa may be obtained from the information acquisition unit 90, such as, at least one of the GPS, the navigation device ND of the vehicle 30, and the various sensors VS of the vehicle 30. The position information on the scheduled charging facility CGx may be obtained from the navigation device ND of the vehicle 30. The vehicle information is information indicating the conditions of the vehicle 30, and may include, for example, at least one of vehicle-speed information indicating the speed of the vehicle 30 and battery information indicating the present state (for example, the SOC and temperature) of the high-voltage battery 34, which may be acquired from the sensors VS of the vehicle 30.

The surrounding information around the vehicle 30 is information indicating the situation around the vehicle 30, and may include at least one of traffic-congestion information around the vehicle 30 and signal information related to traffic signals around the vehicle 30, which may be obtained from the sensors VS of the vehicle 30. The surrounding information on the scheduled charging facility CGx is information indicating the situation around the scheduled charging facility CGx, and may include at least one of traffic-congestion information around the scheduled charging facility CGx and signal information related to traffic signals around the scheduled charging facility CGx, which may be obtained from the sensors VS of the vehicle 30.

The time information is information indicating time related to travel of the vehicle 30, and may include at least one of a current time, which may be obtained from the sensors VS of the vehicle 30. The time information may include a first predicted arrival time at which the vehicle 30 will arrive at the scheduled charging facility CGx predicted at the time when the planned travel route Lr was set, and a second predicted arrival time at which the vehicle 30 will arrive at the scheduled charging facility CGx predicted at the current time.

For example, the charging-facility determination unit 12 may be configured to expand the determination range Rj as the speed of the vehicle 30 becomes higher and/or as the SOC of the high-voltage battery 34 becomes smaller. The charging-facility determination unit 12 may be configured to determine whether the estimated arrival time at the scheduled charging facility CGx falls in daytime or nighttime, and expand the determination range Rj in response to determination that the estimated arrival is at nighttime, because the visibility of the vehicle 30 in nighttime is inferior to that in daytime.

In response to determination that the scheduled charging facility CGx comes within the predetermined determination range Rj (YES in step S202), the notification control routine proceeds to step S203. Otherwise, the scheduled charging facility CGx does not come to fall within the predetermined determination range Rj (NO in step S202), the charging-facility determination unit 12 of the notification system 10 repeats the determination in step S202.

In step S203, the insufficient battery-charge estimation unit 13 of the notification system 10 estimates an insufficient battery-charge possibility, which denotes a possibility that insufficient charge in the high-voltage battery 34 of the vehicle 30 occurs. That is, the insufficient battery-charge possibility means a likelihood of battery-charge insufficiency.

In other words, the insufficient battery charge of the vehicle 30 means that electric power from the high-voltage battery 34 becomes insufficient.

For example, the insufficient battery-charge estimation unit 13 of the notification system 10 estimates the insufficient battery-charge possibility of the vehicle 30 based on (i) start-point position information, which indicates the position of the start point of the travel route Lr, (ii) the vehicle information, and (iii) the position information on the scheduled charging facility CGx.

Specifically, the insufficient battery-charge estimation unit 13 of the notification system 10 compares an arrival-time estimated SOC Xsoc, which is an estimated value of the SOC of the high-voltage battery 34 at a time when the vehicle 30 arrives at the scheduled charging facility CGx, with a predetermined SOC threshold to accordingly estimate the insufficient battery-charge possibility of the vehicle 30. That is, the insufficient battery-charge estimation unit 13 uses the arrival-time estimated SOC Xsoc as an index corresponding to the insufficient battery-charge possibility, and estimates, based on the comparison result, the insufficient battery-charge possibility of the vehicle 30 such that the smaller the arrival-time estimated SOC Xsoc is, the higher the insufficient battery-charge possibility of the vehicle 30 is.

The insufficient battery-charge estimation unit 13 of the notification system 10 for example calculates, during preparation of the travel plan or in the operation in step S209, the arrival-time estimated SOC Xsoc beforehand in accordance with the following formula (F1):

$$Xsoc = \{ Pst - ( Crn + Cac ) \} / CPb \qquad ( F1 )$$

where:
Pst denotes a charge amount of the high-voltage battery 34 at the start point of the travel route Lr;
CPb denotes a charge capacity of the high-voltage battery 34, i.e., a charge amount at full charge of the high-voltage battery 34;
Crn denotes an estimated value of power consumption expended for the travel of the vehicle 30 during an estimation target section that is defined from the start point of the travel route Lr to the scheduled charging facility CGx; and
Cac denotes an estimated value of power consumption expended for air conditioning in the cabin 30a in the estimation target section.

The charge amount Pst at the start point of the travel route Lr may be acquired from the high-voltage battery 34 of the vehicle 30. Alternatively, the charge amount Pst may be estimated from past operation data of the vehicle 30, such as travel history including information on charging and power consumption.

For example, information indicating the charge capacity CPb of the high-voltage battery 34 in the above formula F1 is included in the vehicle information. Because the estimated values Crn and Cac of power consumption are affected by a travel distance of the vehicle 30, the insufficient battery-charge estimation unit 13 may use the start-point position information and the position information on the scheduled charging facility CGx to calculate the estimated values Crn and Cac of power consumption.

The insufficient battery-charge estimation unit 13 may calculate the estimated value Crn of power consumption expended for the travel of the vehicle 30 during the estimation target section in consideration of the speed and the acceleration of the vehicle 30 in the estimation target section, a road gradient and a road resistance in the estimation target section, and a wind speed predicted from weather information around the vehicle 30; the weather information may be acquired by, for example, the sensors VS of the vehicle 30.

The insufficient battery-charge estimation unit 13 may calculate the estimated value Cac of power consumption expended for air conditioning in the cabin 30a in consideration of an outside air temperature predicted from the weather information, a temperature setting of an air-conditioning device in the cabin 30a, an estimated operating time of the air-conditioning device, and strength adjustment of the air conditioning in the cabin 30a included in preference information.

The SOC threshold to be compared with the arrival-time estimated SOC Xsoc denotes a preset value that enables a degree of the insufficient battery-charge possibility to be determined. The SOC threshold may be set as a constant based on an intention of the occupant 80, or may be a variable value that is varied in accordance with travel conditions around the vehicle 30, which include the traffic-congestion around the vehicle 30 and/or the scheduled charging facility CGx, the conditions of the roads around the vehicle 30, and the conditions of the vehicle 30, which may be acquired by, for example, the sensors VS of the vehicle 30.

After calculating the arrival-time estimated SOC Xsoc from the above formula F1 and determining the SOC threshold, the insufficient battery-charge estimation unit 13 of the notification system 10 determines whether the arrival-time estimated SOC Xsoc is less than the SOC threshold to accordingly determine whether the insufficient battery-charge possibility of the vehicle 30 is high in step S203.

In response to determination that the arrival-time estimated SOC Xsoc is greater than or equal to the SOC threshold, the insufficient battery-charge estimation unit 13 determines that the insufficient battery-charge possibility of the vehicle 30 is low (NO in step S203). Otherwise, in response to determination that the arrival-time estimated SOC Xsoc is less than the SOC threshold, the insufficient battery-charge estimation unit 13 determines that the insufficient battery-charge possibility of the vehicle 30 is high (YES in step S203).

In response to determination that the arrival-time estimated SOC Xsoc is greater than or equal to the SOC threshold so that the insufficient battery-charge possibility of the vehicle 30 is low (NO in step S203), the notification control routine proceeds to step S204. Otherwise, in response to determination that the arrival-time estimated SOC Xsoc is less than the SOC threshold so that the insufficient battery-charge possibility of the vehicle 30 is high (YES in step S203), the notification control routine proceeds to step S206.

Following the determination that the insufficient battery-charge possibility of the vehicle 30 is low, the notification unit 14 of the notification system 10 performs a notification using a first notification method in step S204. This notification, which will be referred to as a first notification, indicates that the insufficient battery-charge possibility of the vehicle 30 is low as determined in step S203.

For example, the notification unit 14 operates a notification device 451 included in the HMI unit 45 of the vehicle 30 to accordingly perform the first notification through the notification device 451. This enables the first notification to be provided to the occupant 80 in the form of at least one of a sound, vibration, visual indication, or scent (i.e., olfactory stimulus).

Following the operation in step S204, the storing unit 16 of the notification system 10 stores notification data including (i) a content of the information indicated by the first notification and (ii) information indicative of the first notification having been performed in a storage region 16a that is included in the manager 51 in step S205. The information indicated by the first notification may include information related to the first notification, such as the arrival-time estimated SOC Xsoc that is used as a basis for performing the first notification.

Following the determination that the insufficient battery-charge possibility of the vehicle 30 is high, the notification unit 14 of the notification system 10 performs a notification using a second notification method in step S206. This notification, which will be referred to as a second notification, indicates that the insufficient battery-charge possibility of the vehicle 30 is high as determined in step S203.

For example, the notification unit 14 operates the notification device 451 included in the HMI unit 45 of the vehicle 30 to accordingly perform the second notification through the notification device 451. This enables the second notification to be provided to the occupant 80 in the form of at least one of a sound, vibration, visual indication, or scent.

Following the operation in step S206, the storing unit 16 of the notification system 10 stores notification data including (i) the content of the information indicated by the second notification and (ii) information indicative of the second notification having been performed in the storage region 16a that is included in the manager 51 in step S207. The information indicated by the second notification may include information related to the second notification, such as the arrival-time estimated SOC Xsoc that is used as a basis for performing the second notification.

The first and second notifications will be described later together with a third notification.

Following the operation in step S205 or S207, the reselection unit 15 of the notification system 10 determines whether the scheduled charging facility CGx has been ignored so that the vehicle 30 has passed the scheduled charging facility CGx in step S208. That is, the reselection unit 15 of the notification system 10 repeats the determination in step S208 until the vehicle 30 passes the scheduled charging facility CGx or stops the scheduled charging facility CGx.

For example, the situation where the scheduled charging facility CGx is ignored so that the vehicle 30 passes the scheduled charging facility CGx includes not only a first situation where the vehicle 30 simply passes the road connected to the scheduled charging facility CGx, but also a second situation where the vehicle 30 ignores the road connected to the scheduled charging facility CGx so that the vehicle 30 proceeds ahead.

In response to determination that the scheduled charging facility CGx has been ignored so that the vehicle 30 has passed the scheduled charging facility CGx (YES in step S208), the notification control routine proceeds to step S209. Otherwise, in response to determination that the scheduled charging facility CGx has not been ignored so that the vehicle 30 has been charged at the scheduled charging facility CGx (NO in step S208), the notification control routine proceeds to step S200.

For example, the reselection unit 15 can be configured to monitor the remaining energy of the high-voltage battery 34 to accordingly determine whether the scheduled charging facility CGx has been ignored so that the vehicle 30 has passed the scheduled charging facility CGx in step S208. For example, the reselection unit 15 determines whether the remaining energy of the high-voltage battery 34 has increased to at least a predetermined value during a time period scheduled for arrival at the scheduled charging facility CGx. In response to determination that the remaining energy of the high-voltage battery 34 has increased to at least the predetermined value during the time period scheduled for arrival at the scheduled charging facility CGx, the reselection unit 15 determines that the scheduled charging facility CGx has not been ignored so that the vehicle 30 has been charged at the scheduled charging facility CGx.

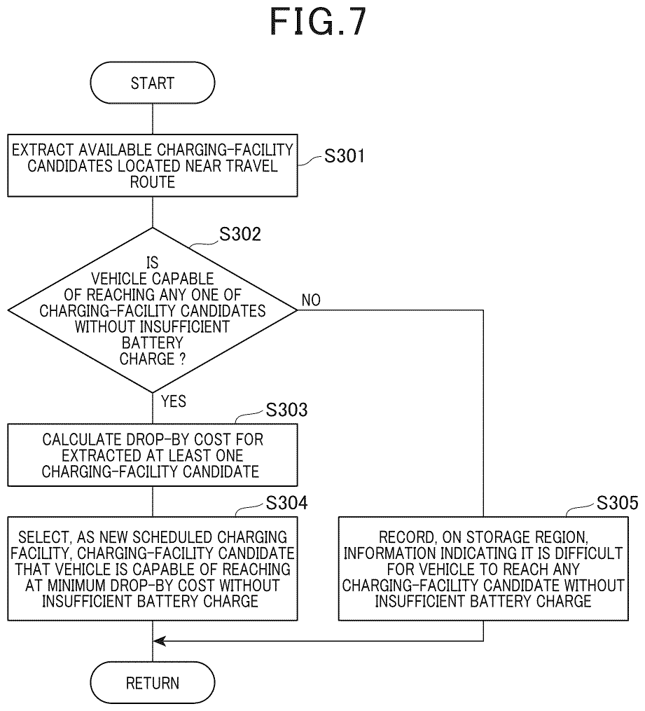

In response to the affirmative determination in step S208, the reselection unit 15 of the notification system 10 reselects a new one of the charging facilities CG as a new scheduled charging facility CGx in place of the ignored scheduled charging facility CGx in step S209. Specifically, the reselection unit 15 is configured to execute a reselection operation in step S209, the detailed operations of which are illustrated as a reselection subroutine in FIG. 7.

When starting the reselection subroutine illustrated in FIG. 7, the reselection unit 15 extracts, from the available charging facilities CG, charging facilities CG located near a portion of the travel route Lr, which is located ahead of the current position Pa of the vehicle 30 in S301; the extracted charging facilities CG will be referred to as charging-facility candidates. Positions of the charging facilities CG can be obtained from, for example, the existing API service 53 or the navigation device ND of the vehicle 30. After the operation in step S301, the reselection subroutine proceeds to step S302.

In step S302, the reselection unit 15 determines whether the vehicle 30 is capable of reaching any one of the charging-facility candidates without insufficient battery charge.

For example, the reselection unit 15 calculates, for each charging-facility candidate, the arrival-time estimated SOC Xsoc in accordance with the above formula F1 as an estimated arrival-time SOC Xsoc of the high-voltage battery 34 at a time when the vehicle 30 arrives at the corresponding charging-facility candidate.

Specifically, when calculating the estimated arrival-time SOC Xsoc of the high-voltage battery 34 for each charging-facility candidate, the reselection unit 15 uses a current charge amount of the high-voltage battery 34 as the charge amount Pst in the above formula F1. Similarly, the reselection unit 15 uses an estimated value of power consumption expended for the travel of the vehicle 30 during a section from the current position Pa of the vehicle 30 to a position of the corresponding charging-facility candidate as the estimated value Crn of power consumption, and uses an estimated value of power consumption expended for air conditioning in the cabin 30a in the section as the estimated value Cac of power consumption.

In response to determination that the estimated arrival-time SOC Xsoc of the high-voltage battery 34 of at least one charging-facility candidate is greater than or equal to 0, which can be expressed as “Xsoc≥0”, the reselection unit 15 determines that the vehicle 30 is capable of reaching the at least one charging-facility candidate without insufficient battery charge, thus extracting the at least one charging-facility candidate from the charging-facility candidates (YES in step S302). Then, the reselection subroutine proceeds step S303.

Otherwise, in response to determination that the estimated arrival-time SOC Xsoc of the high-voltage battery 34 of each charging-facility candidate is less than 0, which can be expressed as “Xsoc<0”, the reselection unit 15 determines that the vehicle 30 is uncapable of reaching any charging-facility candidate without insufficient battery charge (NO in step S302). Then, the reselection subroutine proceeds step S305.

In step S303, the reselection unit 15 calculates, for the extracted at least one charging-facility candidate, a drop-by cost. The drop-by cost for the extracted at least one charging-facility candidate denotes a cost required for the vehicle 30 to drop by at the corresponding extracted at least one charging-facility candidate. The drop-by cost will also be referred to as a drop-by burden that is a burden required for the vehicle 30 to drop by at the corresponding extracted at least one charging-facility candidate.

Following the operation in step S303, the reselection subroutine proceeds to step S304.

In step S304, when extracting plural charging-facility candidates in step S302, the reselection unit 15 selects, as a new scheduled charging facility CGx, one of the extracted charging-facility candidates, the drop-by cost of the one of the extracted charging-facility candidates is minimized. That is, it is determined that the vehicle 30 is capable of reaching, at minimum drop-by cost, the new scheduled charging facility CGx without insufficient battery charge. When extracting a single charging-facility candidate in step S302, the reselection unit 15 selects, as a new scheduled charging facility CGx, the extracted single charging-facility candidate.

For example, the reselection unit 15 calculates the drop-by cost for each charging-facility candidate based on (i) a travel energy efficiency, i.e., energy consumption rate, of the vehicle 30 required for the vehicle 30 to reach the corresponding charging-facility candidate from the current position Pa of the vehicle 30, (ii) a travel time required for the vehicle 30 to reach the corresponding charging-facility candidate from the current position Pa of the vehicle 30, (iii) charging-facility information indicating a situation of the corresponding charging-facility candidate, (iv) the vehicle information indicating the conditions of the vehicle 30, and (v) the preference information on the occupant 80.

That is, the reselection unit 15 selects, from the charging-facility candidates extracted in step S301, the new scheduled charging facility CGx based on (i) the travel energy efficiency, (ii) the travel time, (iii) the charging-facility information, (iv) the vehicle information, and (v) the preference information.

For example, the drop-by cost for each charging-facility candidate calculated in step S303 increases as the travel time of the vehicle 30 for the corresponding charging-facility candidate becomes longer. The reselection unit 15 can be configured to calculate, for each charging-facility candidate, an extra power consumption required for the vehicle 30 to travel via the corresponding charging-facility candidate from the travel route Lr based on the travel energy efficiency, and determine that the drop-by cost for each charging-facility candidate increases as the extra power consumption for the corresponding charging-facility candidate becomes larger. The charging-facility information on each charging-facility candidate includes information, such as charging power and reservation status thereof, and the drop-by cost for each charging-facility candidate increases as reservation thereof is more crowded and/or as charging power thereof is smaller.

The preference information on the occupant 80 used for selection of the new scheduled charging facility CGx from the charging-facility candidates includes, for example, requirements of the occupant 80 regarding (i) the level of congestion at the corresponding charging-facility candidate and (ii) a travel route for the corresponding charging-facility candidate. The preference information also includes, for example, preferences as to whether the occupant 80 places emphasis on travel cost, distance, or time, and information regarding what degree of margin the occupant 80 prefers in the travel plan. The drop-by cost for each charging-facility candidate increases as the drop-by plan of the corresponding charging-facility candidate conflicts more with the preferences of the occupant 80 estimated from the preference information.

Following the negative determination in step S302, the reselection unit 15 or the storing unit 16 records, on for example the storage region 16a, information indicating that it is difficult for the vehicle 30 to reach any charging-facility candidate extracted in step S301 without insufficient battery charge, i.e., battery depletion, in step S305. That is, the reselection unit 15 or the storing unit 16 records, on the storage region 16a, information indicating that insufficient battery charge of the vehicle 30 will occur.

As an example, the reselection unit 15 or the storing unit 16 sets a previously prepared flag in the storage region 16a, which indicates that it is difficult for the vehicle 30 to reach any charging-facility candidate without insufficient battery charge.

When the operation in step S304 or step S305 is completed, that is, the reselection subroutine illustrated in FIG. 7 is terminated, so that the operation in step S209 of the main routine illustrated in FIG. 6 is completed, the main routine, i.e., the notification control routine proceeds to step S210. Note that no new scheduled charging facility CGx is selected in step S305 of the reselection subroutine.

Following the operation in step S209, the insufficient battery-charge estimation unit 13 of the notification system 10 determines whether the vehicle 30 is capable of reaching any charging-facility candidate without insufficient battery charge of the vehicle 30 in step S210.

Specifically, the insufficient battery-charge estimation unit 13 estimates that insufficient battery charge of the vehicle 30 will occur before the vehicle 30 reaches any charging-facility candidate in response to determination that information indicating that it is difficult for the vehicle 30 to reach any charging-facility candidate extracted in step S301 without insufficient battery charge has been recorded in step S305 of FIG. 7.

In response to determination that the vehicle 30 is uncapable of reaching any charging-facility candidate without insufficient battery charge of the vehicle 30 (NO in step S210), the notification control routine proceeds to step S211.

Otherwise, in response to determination that the vehicle 30 is capable of reaching any charging-facility candidate other than the scheduled charging facility CGx without insufficient battery charge of the vehicle 30 (YES in step S210), that is, the vehicle 30 is capable of reaching the new scheduled charging facility CGx selected in step S304 without insufficient battery charge of the vehicle 30, the notification control routine proceeds to step S210. In step S210, information on the new scheduled charging facility CGx selected in step S304 of FIG. 7 is recognized.

In step S211, the notification unit 14 of the notification system 10 performs a notification using a third notification method in step S211. This notification, which will be referred to as a third notification, indicates that the vehicle 30 is uncapable of reaching any charging-facility candidate without insufficient battery charge of the vehicle 30 as determined in step S210.

For example, the notification unit 14 operates the notification device 451 included in the HMI unit 45 of the vehicle 30 to accordingly perform the third notification through the notification device 451. This enables the third notification to be provided to the occupant 80 in the form of at least one of a sound, vibration, visual indication, or scent.

Following the operation in step S211, the storing unit 16 of the notification system 10 stores notification data including (i) the content of the information indicated by the third notification and (ii) information indicative of the third notification having been performed in the storage region 16a that is included in the manager 51 in step S212. The information indicated by the third notification may include information related to the third notification, such as the estimated arrival-time estimated SOC Xsoc calculated for each charging-facility candidate in step S302.

For example, as described above, the first notification, the second notification, and the third notification are each implemented using at least one of sound, vibration, visual indication, and scent. Specifically, the notification unit 14 is configured to operate the notification device 451 included in the HMI unit 45 to accordingly perform the first to third notifications to the occupant through the notification device 451.

For example, if the notification device 451 includes a speaker, the notification unit 14 operates the speaker of the notification device 451 to output sound indicative of each of the first to third notifications through the speaker. As another example, if the notification device 451 includes a display, such as a monitor, the notification unit 14 operates the display of the notification device 451 to output visual information indicative of each of the first to third notifications through the display.

The first notification method, the second notification method, and the third notification method are defined as being mutually different from each other.

Specifically, the types of stimuli, i.e., its output media, such as sound, vibration, visual indication, scent, etc., used by the respective first to third notification methods may be different from each other or the repetition frequencies of the stimuli used by the respective first to third notification methods may differ from each other. If each of the first to third notification methods uses sound as its stimulus, their sound volumes used by the respective first to third notification methods may differ from each other. If each of the first to third notification methods uses vibration as its stimulus, their vibration amounts or vibration amplitudes used by the respective first to third notification methods may differ from each other. If each of the first to third notification methods uses visual indication as its stimulus, their displayed sizes of information used by the respective first to third notification methods may differ from each other if each of the first to third notification methods uses visual indication as its stimulus.

Specifically, the second notification method is previously determined to provide a stronger notification than the first notification method, and the third notification method is previously determined to provide a stronger notification than the second notification method. In other words, the first to third notification methods are configured to output their stimuli in increasing order of strength from the first to third notification method.

For example, when each of the first to third notification methods uses sound as its stimulus, the first to third notification methods are configured to output their sound volumes in increasing order from the first to third notification method.

If each of the first to third notification methods uses sound or vibration as its stimulus, the first to third notification methods are configured to output their notifications for different durations, respectively. In particular, when each of the first to third notification methods uses vibration as its stimulus, the third notification method may repeat a predetermined sound pattern multiple times. When each of the first to third notification methods uses visual indication as its stimulus, the information displayed by the third notification method is more prominent than the information displayed by the second notification method, and the information displayed by the second notification method is more prominent than the information displayed by the first notification method.

As described above, in response to determination that the scheduled charging facility CGx comes within the predetermined determination range Rj during travel of the vehicle 30 (YES in step S202), the notification unit 14 is configured to execute one of the first to third notifications depending on the insufficient battery-charge possibility of the vehicle 30. That is, the notification unit 14 is configured to carry out a notification based on the insufficient battery-charge possibility of the vehicle 30. Each of the first to third notifications according to the first embodiment corresponds to such a notification based on the insufficient battery-charge possibility of the vehicle 30.

The notification unit 14 according to the first embodiment is configured to perform a notification based on the insufficient battery-charge possibility of the vehicle 30 in response to determination that the scheduled charging facility CGx comes within the predetermined determination range Rj as illustrated in FIGS. 4 to 6. This configuration of the first embodiment therefore enables, when the electric vehicle 30 is approaching the scheduled charging facility CGx, the occupant 80 to recognize, through the notification performed based on the insufficient battery-charge possibility of the vehicle 30, not only the fact that the vehicle 30 is approaching the scheduled charging facility CGx but also of the insufficient battery-charge possibility of the vehicle 30. Thus, the notification system 10 of the first embodiment makes it possible to, when the vehicle 30 approaches the scheduled charging facility CGx, appropriately provide a notification that aims to prevent insufficient battery charge, thus preventing the vehicle 30 from passing, due to the driver's inattention, the scheduled charging facility CGx.

The reselection unit 15 of the notification system 10 according to the first embodiment is configured to, when the vehicle 30 has ignored and passed the scheduled charging facility CGx, reselect a new one of the charging facilities CG as a scheduled charging facility CGx in place of the ignored scheduled charging facility CGx. Accordingly, even after the scheduled charging facility CGx has been ignored, this configuration makes it possible to continuously perform a notification related to the reselected charging facility CGx based on the insufficient battery-charge possibility of the vehicle 30.

The notification unit 14 of the notification system 10 according to the first embodiment is configured to execute a notification based on the insufficient battery-charge possibility of the vehicle 30 using the first notification method or the second notification method different from the first notification method.

That is, the notification unit 14 performs a notification based on the first notification method in response to determination that the insufficient battery-charge possibility of the vehicle 30 based on the present SOC of the high-voltage battery 34 is low, and performs a notification based on the second notification method in response to determination that the insufficient battery-charge possibility of the vehicle 30 based on the present SOC of the high-voltage battery 34 is high. Accordingly, this configuration enables the occupant 80 to recognize not only the fact that the vehicle 30 is approaching the scheduled charging facility CGx, but also the level of the insufficient battery-charge possibility.

The notification unit 14 of the notification system 10 according to the first embodiment is configured to execute the first notification indicating that the insufficient battery-charge possibility of the vehicle 30 is low in response to determination that the arrival-time estimated SOC Xsoc is greater than or equal to the SOC threshold. Otherwise, the notification unit 14 of the notification system 10 according to the first embodiment is configured to execute the second notification indicating that the insufficient battery-charge possibility of the vehicle 30 is high in response to determination that the arrival-time estimated SOC Xsoc is less than the SOC threshold.

Accordingly, this configuration, which quantitatively determines the insufficient battery-charge possibility of the vehicle 30, makes it possible to appropriately select one of the first notification based on the first notification method and the second notification based on the second notification method in accordance with the quantitatively determined insufficient battery-charge possibility of the vehicle 30.

The notification unit 14 of the notification system 10 according to the first embodiment is configured to carry out the third notification based on the third notification method that is different from the first and second notification methods in response to determination that insufficient battery charge of the vehicle 30 will occur before the vehicle 30 reaching a scheduled charging facility CGx. This enables the occupant 80 to recognize that continuing travel in the present conditions of the vehicle 30 will lead to insufficient battery charge, and promptly take safety-conscious action in preparation.

The fact that the first to third notification methods are mutually different from one another according to the first embodiment may mean, for example, that the types of the stimuli (sound, vibration, visual indication, scent, etc.), i.e., the types of output media, used by the respective first to third notification methods differ from one another, or that the repetition frequencies of the stimuli used by the respective first to third notification methods differ from one another.

Alternatively, if each of the first to third notification methods uses sound as its output medium, their sound volumes of the first to third notification methods may differ from each other. If each of the first to third notification methods uses vibration as its output medium, their vibration amounts or vibration amplitudes of the first to third notification methods may differ from each other. If each of the first to third notification methods uses visual indication as its output medium, their displayed sizes of information on the first to third notification methods may differ from each other.

Accordingly, the notification unit 14 of the notification system 10 according to the first embodiment is configured to perform the first to third notifications whose differences can be easily recognized by the occupant 80.

The notification unit 14 of the notification system 10 according to the first embodiment is configured to perform each of the first to third notifications using at least one of sound, vibration, visual indication, and scent for the occupant 80. This enables the notification device 451 for implementing the notifications to have a simple configuration.

The storing unit 16 of the notification system 10 according to the first embodiment is configured to, when a notification based on the insufficient battery-charge possibility is carried out, specifically, when any of the first to third notifications is executed, store (i) first information indicating the content of the executed notification and (ii) second information indicating the fact that the notification has been executed in the storage region 16a. This therefore enables the travel history of the vehicle 30 regarding the transition of the SOC of the high-voltage battery 34 to be easily checked afterwards.

The charging facility determination unit 12 of the notification system 10 according to the first embodiment is configured to determine the determination range Rj based on (i) the information on the current position Pa of the vehicle 30, (ii) the information on the position of the scheduled charging facility CGx, (iii) the vehicle information set forth above, (iv) the surrounding information around the vehicle 30, (v) the surrounding information around the scheduled charging facility CGx, and (vi) the time information. The determination unit 12 is configured to determine whether the planned charging facility CGx comes within the determination range Rj during the travel of the vehicle 30. The determination unit 12 is capable of appropriately varying the size of the determination range Rj in accordance with the situation of the vehicle 30, making it possible to perform a notification based on the insufficient battery-charge possibility of the vehicle 30 at appropriate timings.

### OTHER EMBODIMENTS AND MODIFICATIONS

The HMI unit 45 shown in FIG. 2 is provided on the instrument panel in the cabin 30a, which is merely an example.

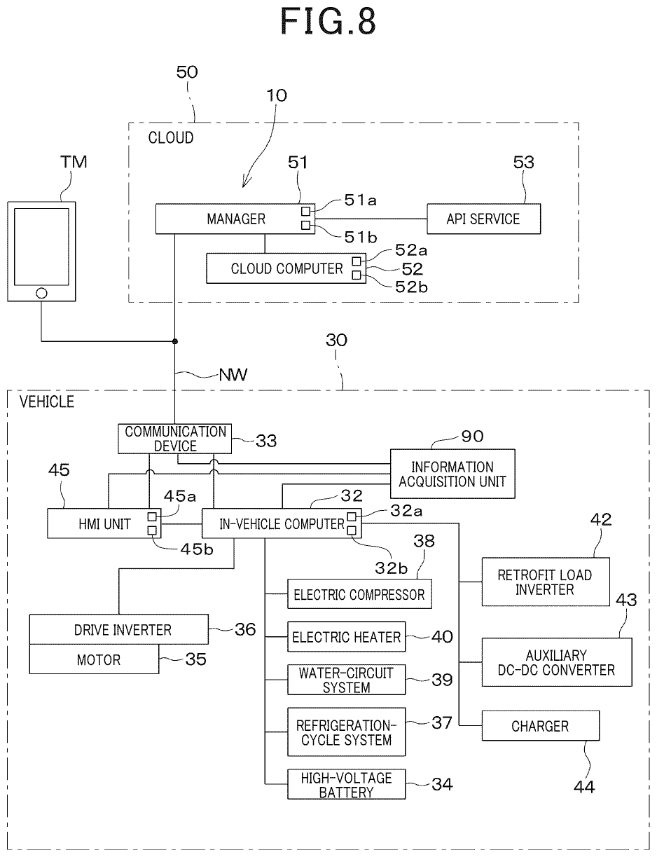

For example, a notification system 80 according to the second embodiment of the present disclosure includes an external terminal TM shown in FIG. 8, which is connectable for data communication to the communication device 33 of the vehicle 30 and the cloud manager 51 via the wireless network NW. The other configuration of the notification system 80 according to the second embodiment is substantially identical to that according to the first embodiment.

In the second embodiment, the external terminal TM is portable and can be carried outside the vehicle 30. That is, the external terminal TM may serve as the HMI unit 45. The external terminal TM may include a notification function as the notification device 451, which is a component of the HMI unit 45. The external terminal TM may be comprised of a portable computer, such as a tablet or a smartphone, operable by the occupant 80.

The HMI unit 45 illustrated in FIG. 2 includes both the input function and output function, which is merely an example. The HMI unit 45 may be implementable with only one of the input and output functions.

The electrical configuration of the vehicle 30 and cloud 50 according to the first embodiment is illustrated in FIG. 2, which is merely an example and therefore is not limited to that illustrated in FIG. 2.

The in-vehicle computer 32 shown in FIG. 2 need not be implemented by a single computer. The in-vehicle computer 32 may be implemented by multiple computers, which are for example provided for respective functions.

The evaluation function used in step S103 of FIG. 3 to determine the various parameters of the travel plan is defined to increase with higher evaluation, which is merely an example. The evaluation function may be defined to decrease with higher evaluation, in which case the parameters may be determined to minimize the value of the evaluation function.

The vehicle 30 is driven by the occupant 80 as a driving entity in FIG. 1, which is merely an example. The vehicle 30 may be implemented as an autonomous vehicle capable of level-4 or level-5 automated driving, in which a system is the driving entity, and the notification control routine illustrated in FIG. 5 is executable during the automated driving.

The control routine illustrated in FIG. 3 is executed primarily by the cloud computer 52, i.e., by the cloud 50, which is merely an example. The control routine illustrated in FIG. 3 may be executed by, for example, an electronic control unit of the vehicle 30. The control routine illustrated in FIG. 3 may be executed by the external terminal TM when the external terminal TM is provided as shown in FIG. 8. The planning of a travel plan, including determination of the travel route Lr and selection of at least one of the charging facilities CG used along the travel route Lr, may be implemented by any of the cloud 50, the vehicle 30, and the external terminal TM.

The charging-facility determination unit 12, the insufficient-battery-charge estimation unit 13, the notification unit 14, the reselection unit 15, and the storage unit 16 illustrated in FIG. 6 are included in the cloud manager 51, which is merely an example. Any part or all of these components may be included in an electronic control unit of the vehicle 30, or, when the external terminal TM is provided as shown in FIG. 8, in the external terminal TM. Specifically, at least one of the components 12, 13, 14, 15, and 16 may be included in any of the cloud 50, the vehicle 30, and the external terminal TM. This makes it possible to improve design flexibility of the notification system 10 using a communication-network environment of the vehicle 30.

The insufficient-battery-charge estimation unit 13 and the notification unit 14 serve as, for example, a notification control unit.

In the control routine illustrated in FIG. 3, the occupant 80 may re-enter information to the cloud computer 52 through the HMI unit 45. Specifically, if the cloud computer 52 cannot determine any travel plan, which avoids insufficient battery charge of the vehicle 30 due to conditions determined based on the input operation from the occupant 80 and the arrangement of charging facilities CG, the cloud computer 52 may be configured to provide, through the HMI unit 45, an error and request, to the occupant 80 through the HMI unit 45, re-entry of input information required to determine a travel plan.

The determination range Rj used in step S202 illustrated in FIG. 5 has a two-dimensional physical region with reference to the current position Pa of the vehicle 30 as shown in FIG. 4, which is merely an example. The determination range Rj may be represented as a distance range along the travel route Lr shown in FIG. 4 or as a temporal range extending up to an estimated time required for the vehicle 30 to reach the scheduled charging facility CGx from the current position Pa.

The determination range Rj used in step S202 of FIG. 5 is determined based on (i) the information on the current position Pa of the vehicle 30, (ii) information on the position of the scheduled charging facility CGx, (iii) the vehicle information set forth above, (iv) surrounding information around the vehicle 30, (v) surrounding information around the scheduled charging facility CGx, and (vi) time information. The present invention is, however, not limited to the above. Any of these pieces of information may be excluded from the determination of the determination range Rj.

The determination range Rj may be determined information other than those pieces of information. The determination range Rj is scalable according to the travel route during travel of the vehicle 30. The determination range Rj may be enlarged when the scheduled charging facility CGx is located along a complicated road network.

The charging-facility determination unit 12 of the notification system 10 according to the first embodiment is configured to determine whether the scheduled charging facility CGx comes within the predetermined determination range Rj while the vehicle 30 is traveling in step S202. The present disclosure is, however, not limited to this configuration.

Specifically, the charging-facility determination unit 12 of the notification system 10 may be configured to perform the determination without directly using the determination range Rj. For example, assuming that a predetermined range defined to correspond to the determination range Rj with reference to the scheduled charging facility CGx, the charging-facility determination unit 12 of the notification system 10 may be configured to determine whether the vehicle 30 falls within the predetermined range during travel of the vehicle 30. This modified determination is equivalent to determination of whether the scheduled charging facility CGx comes within the determination range Rj during travel of the vehicle 30.

The notification control routine illustrated in FIG. 5 is described on the premise that the travel route Lr is preset, which is merely an example.

Specifically, the notification system 10 may be configured to execute the notification control routine illustrated in FIG. 5 without a travel route being previously set. In this modification, the notification system 10 may be configured to select one of the charging facilities CG as a scheduled charging facility CGx at a predetermined timing, and thereafter start the notification control routine illustrated in FIG. 5. The predetermined timing may be defined, for example, (i) when the occupant 80 requests charging of the vehicle 30, (ii) when the SOC of the high-voltage battery 34 falls below a predetermined threshold level during travel of the vehicle 30, or (iii) when the vehicle 30 has traveled a certain distance after the previous charging.

The estimated SOC Xsoc used to estimate the insufficient battery-charge possibility in step S203 illustrated in FIG. 5 is calculated in accordance with the formula (F1), which is merely an example.

Specifically, the insufficient battery-charge estimation unit 13 of the notification system 10 may be configured to calculate the estimated SOC Xsoc in accordance with disturbances in addition to the estimated power consumptions Crn and Cac in the formula (F1). The insufficient battery-charge estimation unit 13 may be configured to calculate the estimated SOC Xsoc based on (i) computer simulations of the traveling of the vehicle 30 or (ii) data indicative of the past travels of the vehicle 30 without using any physical formulas, such as the formula (F1).

The insufficient battery-charge estimation unit 13 may be configured to estimate the insufficient battery-charge possibility based on an estimated remaining energy amount of the high-voltage battery 34 rather than the SOC of the high-voltage battery 34 in step S203. Additionally, the insufficient battery-charge estimation unit 13 may be configured to estimate the insufficient battery-charge possibility based on the estimated remaining energy amount of the high-voltage battery 34 and an estimated energy consumption per distance to the scheduled charging facility CGx. The insufficient battery-charge estimation unit 13 may be configured to estimate the insufficient battery-charge possibility using another parameter correlating with the remaining energy amount of the high-voltage battery 34 instead of the SOC and the remaining energy amount of the high-voltage battery 34.

The insufficient battery-charge estimation unit 13 may be configured to estimate the insufficient battery-charge possibility while considering, after charging of the high-voltage battery 34 at the next scheduled charging facility CGx, charging of the high-voltage battery 34 at an additional charging facility CG located further ahead along the travel route Lr. In this modification, the estimation may be carried out using, in addition to the end-point position information on the travel route Lr and the position information on the scheduled charging facility CGx, position information on the additional charging facility CG.

The insufficient battery-charge estimation unit 13 is configured to estimate, in step S203 of FIG. 5, the insufficient battery-charge possibility based on the estimated SOC Xsoc previously calculated in the control routine illustrated in FIG. 3 or in step S209 of the notification control routine illustrated in FIG. 5 according to the first embodiment, which is merely an example.

For example, the insufficient battery-charge estimation unit 13 may be configured to obtain a present charge amount of the high-voltage battery 34 when estimating the insufficient battery-charge possibility in step S203 and calculate the estimated SOC Xsoc using the obtained charge amount. In this modification, the insufficient battery-charge estimation unit 13 may calculate the estimated SOC Xsoc in accordance with the formula (F1) in which
(I) The charge amount Pst in the formula (F1) is replaced with the obtained present charge amount; and
(II) The estimated values of power consumption Crn and Cac are estimated while the start point of the estimation target section is replaced from the start point of the travel route Lr to the current position Pa.

This modification makes it possible to eliminate, when estimating the insufficient battery-charge possibility in step S203, the need of previously setting the travel route Lr.

In step S203, the insufficient battery-charge estimation unit 13 may be configured to calculate the present SOC or remaining energy amount of the high-voltage battery 34 first, and thereafter calculate the insufficient battery-charge possibility based on the acquired SOC or remaining energy amount. The insufficient battery-charge possibility may be calculated to be low when the SOC or remaining energy amount is greater than or equal to a predetermined threshold and to be high when the SOC or remaining energy amount is less than the predetermined threshold. This modification makes it possible to eliminate, when estimating the insufficient battery-charge possibility in step S203, the need of previously setting the travel route Lr.

In step S203, the insufficient battery-charge estimation unit 13 may be configured to estimate the insufficient battery-charge possibility based on the start-point position information, the vehicle information, and the position information on the scheduled charging facility CGx, which is merely an example. Any of these pieces of information may be excluded from the estimation.

In steps S303 and S304, the reselection unit 15 is configured to select, as a new scheduled charging facility CGx, one of the extracted charging-facility candidates based on (i) the travel energy efficiency, (ii) the travel time, (iii) the charging-facility information, (iv) the vehicle information indicating the conditions of the vehicle 30, and (v) the preference information on the occupant 80. This is, however, merely an example. Specifically, any of these pieces of information may be excluded from the selection.

The reselection unit 15 is configured to reselect a new one of the charging facilities CG as a new scheduled charging facility CGx when the previously scheduled charging facility CGx has been ignored in step S209 of the notification control routine of the first embodiment illustrated in FIG. 5. This reselection of a new scheduled charging facility CGx may be carried out immediately or after the vehicle 30 has traveled a certain distance.

In step S303 of the reselection subroutine illustrated in FIG. 7, the drop-by cost may be calculated using the data indicative of the past travels of the vehicle 30. The reselection unit 15 may be configured to calculate, for each charging-facility candidate, the drop-by cost while considering (i) weather information around the vehicle 30, (ii) a time zone during which the vehicle 30 is traveling, (iii) surroundings around the current position Pa of the vehicle 30, (iv) surroundings around the corresponding charging-facility candidate, and (v) the type of the road adjacent to the corresponding charging-facility candidate.

In step S205 of the notification control routine illustrated in FIG. 5, the storing unit 16 is configured to store, in the storage region 16a in the cloud 50, the notification data including (i) the content of the information indicated by the first notification and (ii) the information indicative of the first notification having been performed in the storage unit 16 in the cloud 50, which is merely an example. The storing of the notification data in the storage region 16a in the cloud 50 may be omitted.

In step S205 of the notification control routine illustrated in FIG. 5, the storing unit 16 may be configured to store, in the storage region 16a in the cloud 50, the notification data, and transmit the notification data to one or both of (i) at least one surrounding vehicle traveling around the vehicle 30 and (ii) at least one surrounding facility, such as a parking lot, located around the vehicle 30, which are communicably connected to the vehicle 30 via the wireless network NW. When the notification data is received by the at least one surrounding vehicle or the at least one surrounding facility, the notification data may be stored therein. The same may be applied to the operation in step S207 or S212 of the notification control routine illustrated in FIG. 5.

Transmitting the notification information based on one of the first notification, second notification, and third notification to at least one of (i) the cloud 50, (ii) the at least one surrounding vehicle, (iii) the at least one surrounding facility makes it possible to prevent loss of the notification information even if the vehicle 30 is damaged. Notifying the insufficient battery-charge possibility of the vehicle 30 to at least one of (i) the cloud 50, (ii) the at least one surrounding vehicle, (iii) the at least one surrounding facility results in an improvement of the safety of the vehicle 30.

In step S208 of the notification control routine illustrated in FIG. 5, the reselection unit 15 is configured to monitor the remaining energy of the high-voltage battery 34 to accordingly determine whether the scheduled charging facility CGx has been ignored so that the vehicle 30 has passed the scheduled charging facility CGx in step S208. This configuration is merely an example.

Specifically, the reselection unit 15 may be configured to determine whether the current position Pa of the vehicle 30, which is recognized by, for example, at least one of the sensors VS of the vehicle 30, the GPS, and/or the external terminal TM, has been stopped at the position of the scheduled charging facility CGx for a predetermined period to accordingly determine whether the scheduled charging facility CGx is ignored so that the vehicle 30 has been charged at the charging facility CGx in step S208 of the notification control routine illustrated in FIG. 5. That is, the reselection unit 15 may be configured to determine that the scheduled charging facility CGx is not ignored so that the vehicle 30 has been charged at the charging facility CGx in response to determination that the current position Pa of the vehicle 30 has been stopped at the position of the scheduled charging facility CGx for the predetermined period.

The notification method, timing, or content of the first notification in step S204 of the notification control routine illustrated in FIG. 5 may be changed depending on whether the scheduled charging facility CGx has once been determined to be ignored in step S208. The same may be applied to the second notification in step S206.

The notification control routine illustrated in FIG. 5 is terminated when the occupant 80 continues to drive in deviation from the travel plan beyond a predetermined allowable limit during execution of the notification control routine illustrated in FIG. 5 according to the first embodiment. After the termination of the notification control routine, the travel plan may be automatically updated. In the updated travel plan, the destination is maintained without being changed.

When the travel plan is updated to a new travel plan, the notification control routine illustrated in FIG. 5 is configured to be restarted from step S201 regardless of whether the vehicle 30 is stopped or traveling. For example, the control routine illustrated in FIG. 3 may perform the updating of the travel plan. In particular, the control routine illustrated in FIG. 3 may be started from step S102 instead of step S101, so that the operation in step S101 may not be performed, because the occupant's input of, for example, the destination of the new travel plan is unnecessary in the updating of the travel plan.

The operation in each step illustrated in the flowcharts of FIGS. 3, 5, and 7, which is implemented by one or more computer programs, may be implementable by hardware.

While the illustrative exemplary embodiments of the present disclosure have been described herein, the present disclosure is not limited to the exemplary embodiments and their configurations described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

One or more components in each of the exemplary embodiments are not necessarily essential components except for (i) one or more components that are described as one or more essential components or (ii) one or more components that are essential in principle.

Specific values disclosed in each of the exemplary embodiments, each of which represents the number of components, a physical quantity, and/or a range of a physical parameter, are not limited thereto except that (i) the specific values are obviously essential or (ii) the specific values are essential in principle.

In the exemplary embodiments, any mention of the materials, shapes, relative positions, etc., of components is not intended to be limiting, unless otherwise specified or where inherently limited by principle.

Sensors for acquiring external environmental information of the vehicle 30 (e.g., an outside air temperature) described in the above embodiment may be omitted, and the external environmental information may instead be received from an external server of the vehicle 30 or from the cloud 50. The sensors may alternatively be omitted, and the vehicle 30 may obtain related information associated with the external environmental information from an external server or the cloud 50 and estimate the external environmental information based on the obtained related information.

The notification system 10 according to the present disclosure includes multiple control functional units, such as the charging-facility determination unit 12, the insufficient battery-charge estimation unit 13, the notification unit 14, and the reselection unit 15 shown in FIG. 6, which execute the operations in steps included in the flowcharts of FIGS. 3, 5, and 7. The control functional units and their methods described in the present disclosure may be implemented by a dedicated computer including a memory and a processor configured to execute one or more functions realized by one or more computer programs. The control functional units and their methods may also be implemented by a dedicated computer provided by one or more dedicated hardware logic circuits that configure the processor. The control functional units and their methods may further be implemented by a dedicated computer configured by a combination of (i) a memory and a processor programmed to execute one or more functions and (ii) a processor configured by one or more hardware logic circuits. The computer programs may be stored, as instructions to be executed by a computer, in a non-transitory tangible storage medium that is readable by the computer.

As used herein, “control circuitry” encompasses hardware implemented to perform the described functions, including one or more processors executing instructions, digital logic such as ASICs (“Application Specific Integrated Circuits”) and FPGAS (“Field Programmable Gate Arrays”), or combinations thereof. The phrase “configured to” is used to denote structure arranged to perform the recited function during operation and is not intended to invoke 35 U.S.C. § 112(f) absent express “means for” language.

The control circuitry may be implemented in or as part of any one or more of a manager, a cloud computer, an in-vehicle computer, and an HMI unit of the notification system 10. In certain embodiments, different portions of the control circuitry execute on different components and collectively implement the functions described herein.

The control circuitry may be configured to cause an appropriate portion of the notification system 10 to execute one or more functions as recited in each claim. Such configurations include implementations in which the control circuitry itself executes some or all of the claimed functions.

The following describes features of the present disclosure.

### [First Feature]

A notification system according to the first feature for an electric vehicle (30) that travels based on power acquired from a secondary battery (34). The system includes a charging facility determination unit (12) configured to determine, during traveling of the electric vehicle, whether a charging facility (CG, CGx) comes within a predetermined determination range (Rj) defined with reference to a current position (Pa) of the electric vehicle. The system includes a notification control unit (13, 14) configured to estimate an insufficient battery-charge possibility of the electric vehicle, the insufficient battery-charge possibility denoting a possibility that an insufficient charge of the secondary battery of the electric vehicle occurs, and perform a notification based on the insufficient battery-charge possibility of the electric vehicle in response to determination that the charging facility comes within the predetermined determination range.

### [Second Feature]

In the notification system according to the second feature, which depends from the first feature, the notification control unit is configured to estimate the insufficient battery-charge possibility based on (i) start-point position information indicating a position of a start point of a predetermined travel route of the electric vehicle, (ii) vehicle information indicating a condition of the electric vehicle, and (iii) position information on the charging facility.

### [Third Feature]

The notification system according to the third feature, which depends from the first or second feature, further includes a reselection unit (15). The charging facility is previously selected as a scheduled charging facility. The reselection unit is configured to determine whether the scheduled charging facility has been ignored so that the electric vehicle has passed the scheduled charging facility, and reselect, from one or more charging-facility candidates, a charging-facility candidate as a new scheduled charging facility in response to determination that the scheduled charging facility has been ignored so that the electric vehicle has passed the scheduled charging facility.

### [Fourth Feature]

In the notification system according to the fourth feature, which depends from the third feature, the reselection unit is configured to reselect, from the one or more charging-facility candidates, the charging-facility candidate as the new scheduled charging facility based on at least one of:
(i) a travel energy efficiency of the electric vehicle required for the electric vehicle 30 to reach each of the charging-facility candidates from the current position of the electric vehicle;
(ii) a travel time required for the electric vehicle to reach each of the charging-facility candidates from the current position of the electric vehicle;
(iii) charging-facility information indicating a situation of each of the charging-facility candidates;
(iv) vehicle information indicating a condition of the electric vehicle; or
(v) preference information on an occupant (80) of the electric vehicle.

### [Fifth Feature]

In the notification system according to the fifth feature, which depends from the third or fourth feature, the reselection unit is included in any one of: a cloud server communicable with the electric vehicle; and an external terminal (TM) communicable with the electric vehicle.

### [Sixth Feature]

In the notification system according to the sixth feature, which depends from any one of the first to fifth features, the notification unit is configured to perform the notification based on the insufficient battery-charge possibility of the electric vehicle using a first notification method or a second notification method that is different from the first notification method. The notification unit is configured to select, based on a level of the insufficient battery-charge possibility of the electric vehicle, one of the first notification method and the second notification method to perform the notification.

### [Seventh Feature]

In the notification system according to the seventh feature, which depends from the sixth feature, the reselection unit is configured to determine whether a state of charge of the secondary battery is greater than or equal to a predetermined threshold, and perform the notification based on the insufficient battery-charge possibility of the electric vehicle using the first notification method in response to determination that the state of charge of the secondary battery is greater than or equal to the predetermined threshold. The reselection unit is additionally configured to perform the notification based on the insufficient battery-charge possibility of the electric vehicle using the second notification method in response to determination that the state of charge of the secondary battery is less than the predetermined threshold.

### [Eighth Feature]

The notification system according to the eighth feature, which depends from the sixth or seventh feature, further includes an insufficient battery-charge possibility estimation unit configured to estimate whether the electric vehicle is capable of reaching the charging facility without insufficient battery charge of the electric vehicle. The notification unit is configured to perform the notification based on the insufficient battery-charge possibility of the electric vehicle using a third notification method different from the first and second notification methods.

### [Ninth Feature]

In the notification system according to the ninth feature, which depends from the eighth feature, the first notification method, the second notification method, and the third notification method being mutually different from each other is defined as at least one of:
(i) types of stimulus used by the respective first, second, and third notification methods are different from one another;
(ii) repetition frequences of the stimuli used by the respective first, second, and third notification methods are different from one another;
(iii) volumes of sound used by the respective first, second, and third notification methods are different from one another if each of first to third notification methods uses the sound as its stimulus;
(iv) amounts of vibration used by the respective first, second, and third notification methods are different from one another if each of first to third notification methods uses the vibration as its stimulus;
(v) amplitude of the vibration used by the respective first, second, and third notification methods are different from one another if each of first to third notification methods uses the vibration as its stimulus; and
(vi) displayed sizes of information used by the respective first, second, and third notification methods are different from one another if each of first to third notification methods uses visual indication as its stimulus.

### [Tenth Feature]

In the notification system according to the tenth feature, which depends from any of the first to third features, the notification unit is configured to provide, to an occupant (80) of the electric vehicle, the notification based on the insufficient battery-charge possibility of the electric vehicle using at least one of sound, vibration, visual indication, or scent as its stimulus.

### [Eleventh Feature]

In the notification system according to any one of the first to tenth features, wherein information indicative of the notification based on the insufficient battery-charge possibility of the electric vehicle performed by the notification unit is configured to be transmitted to at least one of: a cloud server communicable with the electric vehicle, or an external terminal (TM) communicable with the electric vehicle.

### [Twelfth Feature]

The notification system according to the twelfth feature, which depends from any one of the first to eleventh features, further includes a storing unit (16) configured to store, in a predetermined storage region (16a), first information indicating a content of the notification performed by the notification unit and second information indicating a fact that the notification has been performed.

### [Thirteenth Feature]

In the notification system according to the thirteenth feature, which depends from any one of the first to twelfth features, the charging facility determination unit is configured to determine the predetermined determination range in accordance with at least one of:
(i) current position information on the current position of the electric vehicle;
(ii) facility position information on a position of the charging facility;
(iii) vehicle information indicating a condition of the electric vehicle;
(iv) surrounding information around the electric vehicle or the charging facility; or
(v) time information indicating time related to travel of the electric vehicle.

The charging facility determination unit is configured to determine, during traveling of the electric vehicle, whether the charging facility comes within the determined determination range.

### [Fourteenth Feature]

In the notification system according to the fourteenth feature, which depends from the thirteenth feature, the charging facility determination unit is configured to receive the current position information from at least one of (i) a global positioning system, (ii) a navigation device of the electric vehicle, or (iii) one or more sensors of the electric vehicle. The charging facility determination unit is configured to receive the facility position information from the navigation device of the electric vehicle. The vehicle information includes at least one of (i) speed information indicative of a speed of the electric vehicle or (ii) battery information indicative of a state of the secondary battery. The surrounding information includes at least one of (i) traffic-congestion information around the electric vehicle or the charging facility or (ii) signal information related to at least one traffic signal around the electric vehicle or the charging facility. The time information includes at least one of (i) a current time, (ii) a first predicted arrival time at which the electric vehicle will arrive at the charging facility predicted at a time when a predetermined scheduled travel route was set, or (iii) a second predicted arrival time at which the electric vehicle will arrive at the charging facility predicted at the current time.

### [Fifteenth Feature]

A program product according to the fifteenth feature for an electric vehicle (30) that travels based on power acquired from a secondary battery (34) stores computer-program instructions. The computer-program instructions cause a processor to:
(i) determine, during traveling of the electric vehicle, whether a charging facility (CG, CGx) comes within a predetermined determination range (Rj) defined with reference to a current position (Pa) of the electric vehicle;
(ii) estimate an insufficient battery-charge possibility of the electric vehicle, the insufficient battery-charge possibility denoting a possibility that an insufficient charge of the secondary battery of the electric vehicle occurs; and
(iii) perform a notification based on the insufficient battery-charge possibility of the electric vehicle in response to determination that the charging facility comes within the predetermined determination range.

### [Sixteenth Feature]

A notification method according to the sixteenth feature for an electric vehicle (30) that travels based on power acquired from a secondary battery (34) includes:
(i) determining, during traveling of the electric vehicle, whether a charging facility (CG, CGx) comes within a predetermined determination range (Rj) defined with reference to a current position (Pa) of the electric vehicle;
(ii) estimating an insufficient battery-charge possibility of the electric vehicle, the insufficient battery-charge possibility denoting a possibility that an insufficient charge of the secondary battery of the electric vehicle occurs; and
(iii) performing a notification based on the insufficient battery-charge possibility of the electric vehicle in response to determination that the charging facility comes within the predetermined determination range.

1. A notification system for an electric vehicle that travels based on power acquired from a secondary battery, the system comprising:
control circuitry configured to cause the system to:
determine, during traveling of the electric vehicle, whether a charging facility comes within a predetermined determination range defined with reference to a current position of the electric vehicle; and
estimate an insufficient battery-charge possibility of the electric vehicle, the insufficient battery-charge possibility denoting a possibility that an insufficient charge of the secondary battery of the electric vehicle occurs; and
perform a notification based on the insufficient battery-charge possibility of the electric vehicle in response to determination that the charging facility comes within the predetermined determination range.

2. The notification system according to claim 1, wherein:
the control circuitry is configured to cause the system to estimate the insufficient battery-charge possibility based on:
start-point position information indicating a position of a start point of a predetermined travel route of the electric vehicle;
vehicle information indicating a condition of the electric vehicle; and
position information on the charging facility.

3. The notification system according to claim 1, wherein:
the charging facility is previously selected as a scheduled charging facility; and
the control circuitry is configured to cause the system to:
determine whether the scheduled charging facility has been ignored so that the electric vehicle has passed the scheduled charging facility; and
reselect, from one or more charging-facility candidates, a charging-facility candidate as a new scheduled charging facility in response to determination that the scheduled charging facility has been ignored so that the electric vehicle has passed the scheduled charging facility.

4. The notification system according to claim 3, wherein:
the control circuitry is configured to cause the system to reselect, from the one or more charging-facility candidates, the charging-facility candidate as the new scheduled charging facility based on at least one of:
a travel energy efficiency of the electric vehicle required for the electric vehicle to reach each of the charging-facility candidates from the current position of the electric vehicle;
a travel time required for the electric vehicle to reach each of the charging-facility candidates from the current position of the electric vehicle;
charging-facility information indicating a situation of each of the charging-facility candidates;
vehicle information indicating a condition of the electric vehicle; or
preference information on an occupant of the electric vehicle.

5. The notification system according to claim 3, wherein:
the control circuitry is included in any one of:
a cloud server communicable with the electric vehicle; and
an external terminal communicable with the electric vehicle.

6. The notification system according to claim 1, wherein:
the control circuitry is configured to cause the system to:
perform the notification based on the insufficient battery-charge possibility of the electric vehicle using a first notification method or a second notification method that is different from the first notification method; and
select, based on a level of the insufficient battery-charge possibility of the electric vehicle, one of the first notification method and the second notification method to perform the notification.

7. The notification system according to claim 6, wherein:
the control circuitry is configured to cause the system to:
determine whether a state of charge of the secondary battery is greater than or equal to a predetermined threshold;
perform the notification based on the insufficient battery-charge possibility of the electric vehicle using the first notification method in response to determination that the state of charge of the secondary battery is greater than or equal to the predetermined threshold; and
perform the notification based on the insufficient battery-charge possibility of the electric vehicle using the second notification method in response to determination that the state of charge of the secondary battery is less than the predetermined threshold.

8. The notification system according to claim 6, wherein:
the control circuitry is configured to cause the system to:
estimate whether the electric vehicle is capable of reaching the charging facility without insufficient battery charge of the electric vehicle; and
perform the notification based on the insufficient battery-charge possibility of the electric vehicle using a third notification method different from the first and second notification methods.

9. The notification system according to claim 8, wherein:
the first notification method, the second notification method, and the third notification method being mutually different from each other is defined as at least one of:
(i) types of stimulus used by the respective first, second, and third notification methods are different from one another;
(ii) repetition frequences of the stimuli used by the respective first, second, and third notification methods are different from one another;
(iii) volumes of sound used by the respective first, second, and third notification methods are different from one another if each of first to third notification methods uses the sound as its stimulus;
(iv) amounts of vibration used by the respective first, second, and third notification methods are different from one another if each of first to third notification methods uses the vibration as its stimulus;
(v) amplitude of the vibration used by the respective first, second, and third notification methods are different from one another if each of first to third notification methods uses the vibration as its stimulus; and
(vi) displayed sizes of information used by the respective first, second, and third notification methods are different from one another if each of first to third notification methods uses visual indication as its stimulus.

10. The notification system according to claim 1, wherein:
the control circuitry is configured to cause the system to provide, to an occupant of the electric vehicle, the notification based on the insufficient battery-charge possibility of the electric vehicle using at least one of sound, vibration, visual indication, or scent as its stimulus.

11. The notification system according to claim 1, wherein:
information indicative of the notification based on the insufficient battery-charge possibility of the electric vehicle performed by the notification unit is configured to be transmitted to at least one of:
a cloud server communicable with the electric vehicle; or
an external terminal communicable with the electric vehicle.

12. The notification system according to claim 1, wherein:
the control circuitry is configured to cause the system to store, in a predetermined storage region, first information indicating a content of the notification performed by the notification unit and second information indicating a fact that the notification has been performed.

13. The notification system according to claim 1, wherein:
the control circuitry is configured to cause the system to:
determine the predetermined determination range in accordance with at least one of:
(i) current position information on the current position of the electric vehicle;
(ii) facility position information on a position of the charging facility;
(iii) vehicle information indicating a condition of the electric vehicle;
(iv) surrounding information around the electric vehicle or the charging facility; or
(v) time information indicating time related to travel of the electric vehicle; and
determine, during traveling of the electric vehicle, whether the charging facility comes within the determined determination range.

14. The notification system according to claim 13, wherein:
the control circuitry is configured to cause the system to receive:
the current position information from at least one of (i) a global positioning system, (ii) a navigation device of the electric vehicle, or (iii) one or more sensors of the electric vehicle; and
the facility position information from the navigation device of the electric vehicle;
the vehicle information includes at least one of (i) speed information indicative of a speed of the electric vehicle or (ii) battery information indicative of a state of the secondary battery;
the surrounding information includes at least one of (i) traffic-congestion information around the electric vehicle or the charging facility or (ii) signal information related to at least one traffic signal around the electric vehicle or the charging facility; and
the time information includes at least one of (i) a current time, (ii) a first predicted arrival time at which the electric vehicle will arrive at the charging facility predicted at a time when a predetermined scheduled travel route was set, or (iii) a second predicted arrival time at which the electric vehicle will arrive at the charging facility predicted at the current time.

15. A program product for an electric vehicle that travels based on power acquired from a secondary battery, the program product comprising:
a non-transitory storage medium; and
computer-program instructions stored in the non-transitory storage medium,
the computer-program instructions causing a processor to:
determine, during traveling of the electric vehicle, whether a charging facility comes within a predetermined determination range defined with reference to a current position of the electric vehicle;
estimate an insufficient battery-charge possibility of the electric vehicle, the insufficient battery-charge possibility denoting a possibility that an insufficient charge of the secondary battery of the electric vehicle occurs; and
perform a notification based on the insufficient battery-charge possibility of the electric vehicle in response to determination that the charging facility comes within the predetermined determination range.

16. A notification method for an electric vehicle that travels based on power acquired from a secondary battery, the notification method comprising:
determining, during traveling of the electric vehicle, whether a charging facility comes within a predetermined determination range defined with reference to a current position of the electric vehicle;
estimating an insufficient battery-charge possibility of the electric vehicle, the insufficient battery-charge possibility denoting a possibility that an insufficient charge of the secondary battery of the electric vehicle occurs; and
performing a notification based on the insufficient battery-charge possibility of the electric vehicle in response to determination that the charging facility comes within the predetermined determination range.
